(19) United States
(12) Patent Application Publication
(10) Pub. No.: US 2018/0152622 A1
(43) Pub. Date: May 31, 2018

(54) MOBILE TERMINAL-BASED PHOTOGRAPHING METHOD AND MOBILE TERMINAL

(71) Applicant: Huizhou TCL Mobile Communication Co., LTD, Hui Zhou (CN)

(72) Inventor: Ziyu Wang, Hui Zhou (CN)

(21) Appl. No.: 15/505,862

(22) PCT Filed: Dec. 1, 2015
(86) PCT No.: PCT/CN2016/094451

§ 371 Date: Feb. 22, 2017

(30) Foreign Application Priority Data
Dec. 1, 2015 (CN) 201510875187.4

(51) Int. Cl. H04N 5/232; G06F 3/01; G06F 3/0481

(52) U.S. Cl. CPC H04N 5/23216; H04N 5/23293; H04M 2250/52; G06F 3/0481; G06F 3/017

(57) ABSTRACT

The present invention discloses a mobile terminal-based photo-taking method and said mobile terminal, the method comprising: after determining that the camera is working in the window view mode before an application needs to call the camera to shoot, the mobile terminal sets the view window of the camera in a small screen display mode on the application interface of the application, such that, when a click action on the view window is detected, the camera is called to shoot a picture. The operations are simple and convenient, and the user experience is improved.

### FIELD OF THE INVENTION

The present invention relates to the field of communication technologies, and in particular to a mobile terminal-based photographing method and said mobile terminal.

### DESCRIPTION OF THE RELATED ART

Taking pictures is one of the common functions of cell phones. Full-screen is a default photographing mode for all existing cell phones. In some applications, such as chatting or writing an email, it is necessary to take a picture in real time and instantly add the picture into a chat window or an email, it is very cumbersome to use the full-screen to take the photo at this moment, and the screen experiences a significant change during full-screen photographing, which tends to attract people nearby to look. In addition, full-screen photographing typically has a default button, and the button must be pressed to take a picture, leading to inconvenient operations.

### SUMMARY OF THE INVENTION

The present invention provides a mobile terminal-based photo-taking method and said mobile terminal, so as to use a small screen to shoot when an application is running. The operations are simple and convenient, and the user experience is improved.

A first aspect of the present invention provides a mobile terminal, comprising: a processor, a memory and a communication bus, the communication bus is connected to the processor and the memory, respectively, the memory is used to store a program, and the processor is used to execute the program in the memory; the program is used to:

Provide a selection interface for a user to select a full-screen view mode or a window view mode in which a camera works when the camera needs to be called for photographing during the running of an application, and record the user selection;

Determine if the camera is working in the window view mode before an application needs to call the camera to shoot;

Set the view window of the camera in a small screen display mode on the application interface of the application when the program determines that the camera is working in the window view mode;

Display the view window of the camera in a full-screen display mode when a preset gesture action is detected on the view window displayed in a small screen display mode;

Call the camera to shoot a picture when a click action on the view window is detected or a physical side button of the mobile terminal is pressed;

Place the picture in the view window.

Wherein, the program presets a preset condition for an application to call the camera, and the program further determines if the step of an application to call the camera to shoot meets the preset condition, wherein the preset condition is:

The camera icon on the application interface of the application is clicked; or

The side button of the mobile terminal is pressed.

Wherein, the program sets the view window in such a way that, when a user clicks the edge of the view window and conducts a drag action, its position moves in the dragging direction.

Wherein, the program sets the view window in such a way that, when it is dragged to an operating field of the application interface, the picture is used as an operating object of the operating field.

Wherein, the program is further used to, when it is determined that the camera is not working in the window view mode, display the view window of the camera in a full-screen display mode.

Wherein, the program is further used to, when a double click operation is detected on the view window displayed in a full-screen display mode, set the view window of the camera in a small screen display mode on the application interface of the application.

Wherein, the preset gesture action is a two-finger expand gesture.

A second aspect of the present invention provides a mobile terminal, comprising: a processor, a memory and a communication bus, the communication bus is connected to the processor and the memory, respectively, the memory is used to store a program, and the processor is used to execute the program in the memory; the program is used to:

Provide a selection interface for a user to select a full-screen view mode or a window view mode in which a camera works when the camera needs to be called for photographing during the running of an application, and record the user selection;

Determine if the camera is working in the window view mode before an application needs to call the camera to shoot;

Set the view window of the camera in a small screen display mode on the application interface of the application when the program determines that the camera is working in the window view mode;

Display the view window of the camera in a full-screen display mode when a preset gesture action is detected on the view window displayed in a small screen display mode;

Call the camera to shoot a picture when a click action on the view window is detected or a physical side button of the mobile terminal is pressed.

Wherein, the program is further used to place the picture in the view window, and the program sets the view window in such a way that, when a user clicks the edge of the view window and conducts a drag action, its position moves in the dragging direction, and when the view window is dragged to an operating field of the application interface, uses the picture as an operating object of the operating field.

Wherein, the program is further used to, when it is determined that the camera is not working in the window view mode, display the view window of the camera in a full-screen display mode; when a double click operation is detected on the view window displayed in a full-screen display mode, set the view window of the camera in a small screen display mode on the application interface of the application.

Wherein, the program is further used to, when a preset gesture action is detected on the view window displayed in a small screen display mode, display the view window of the camera in a full-screen display mode, the preset gesture action being a two-finger expand gesture.

A third aspect of the present invention provides a mobile terminal-based photographing method, comprising: providing a selection interface for a user to select a full-screen view mode or a window view mode in which a camera works when the camera needs to be called for photographing during the running of an application, and recording the user selection;

Determining if the camera is working in the window view mode before an application needs to call the camera to shoot;

If yes, setting the view window of the camera in a small screen display mode on the application interface of the application;

Calling the camera to shoot a picture when a click action on the view window is detected or a physical side button of the mobile terminal is pressed.

Wherein, the step that an application needs to call the camera to shoot is carried out when a preset condition is met, wherein the preset condition is: the camera icon on the application interface of the application is clicked; or the side button of the mobile terminal is pressed.

Wherein, after the step of calling the camera to shoot a picture when a click action on the view window is detected, the method further comprises: placing the picture in the view window.

Wherein, the view window is set in such a way that, when a user clicks the edge of the view window and conducts a drag action, its position moves in the dragging direction.

Wherein, when the view window is dragged to an operating field of the application interface, the picture is used as an operating object of the operating field.

Wherein, the method further comprises: when it is determined that the camera is not working in the window view mode, displaying the view window of the camera in a full-screen display mode.

Wherein, the method further comprises: when a double click operation is detected on the view window displayed in a full-screen display mode, setting the view window of the camera in a small screen display mode on the application interface of the application.

Wherein, the method further comprises: when a preset gesture action is detected on the view window displayed in a small screen display mode, displaying the view window of the camera in a full-screen display mode.

Wherein, the preset gesture action is a two-finger expand gesture.

With the above solutions, the present invention has the following advantageous effects: unlike the prior art, the present invention provides a selection interface in advance and records the selection by a user of a full-screen view mode or a window view mode in which a camera works when the camera needs to be called for photographing during the running of an application, consequently when determining that the camera is working in the window view mode before an application needs to call the camera to shoot, the present invention sets the view window of the camera in a small screen display mode on the application interface of the application, such that the camera can be called to shoot a picture when a click action on the view window is detected, thereby simplifying the user operation and improving the user experience.

### BRIEF DESCRIPTION OF THE DRAWINGS

FIG. 1 is a flow chart of a first embodiment of a mobile terminal-based photographing method according to the present invention;

FIG. 2 is a flow chart of a second embodiment of a mobile terminal-based photographing method according to the present invention;

FIG. 3 is a schematic diagram that the view window is displayed in the small screen display mode on an application interface of an application and is dragged according to the present invention;

FIG. 4 is a schematic diagram that the window view mode and the full-screen view mode of the camera are switched mutually according to the present invention;

FIG. 5 is a block diagram of the principle of the mobile terminal according to the present invention;

FIG. 6 is a structural schematic diagram of the hardware of the mobile terminal according to the present invention.

### DETAILED DESCRIPTION OF THE SPECIFIC EMBODIMENTS

To make the technical problem to be solved by the present invention, technical solutions and advantageous effects of the present invention clearer and more specific, the present invention will be further described in detail below with reference to the accompanying drawings and specific embodiments. It should be understood that the specific embodiments described herein are only used to explain the present invention, and not used to limit the present invention.

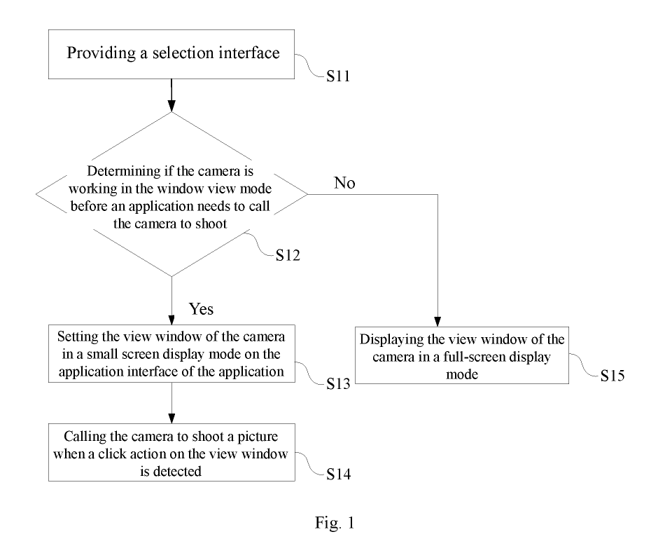

Referring to FIG. 1, FIG. 1 is a flow chart of a first embodiment of a mobile terminal-based photographing method according to the present invention. As shown in FIG. 1, the photographing method according to the present embodiment comprises:

S11: providing a selection interface.

The mobile terminal presets a default start mode for a camera when the camera needs to be called for photographing during the running of an application, the default start mode comprising a full-screen view mode or a window view mode. In the present embodiment, the mobile terminal provides a selection interface in advance, for a user to select whether the camera works in the full-screen view mode or the window view mode when the camera needs to be called for photographing during the running of an application, and records the user selection.

S12: determining if the camera is working in the window view mode before an application needs to call the camera to shoot.

When the mobile terminal detects that the camera icon on an application interface of an application is clicked or a side button of the mobile terminal is pressed, it further acquires the recorded work mode of the camera that is selected by the user, and determines if the camera is working in the window view mode, if yes, go to Step S13, if no, go to Step S15.

S13: setting the view window of the camera in a small screen display mode on the application interface of the application.

When the mobile terminal starts a photographing program and determines that the default start mode of a camera selected by the user is the view window mode, it sets the view window of the camera in a small screen display mode on the application interface of the application. Preferably, the view window floats in a small screen mode above the application interface of the application, and the view window does not affect the operation of the current application, as shown in FIG. 3, the view window 30 floats above the application interface 31 of the current application.

S14: calling the camera to shoot a picture when a click action on the view window is detected.

Wherein, when a click action on the view window is detected, or a physical side button of the mobile terminal is pressed, or other shortcut commands for calling the camera to shoot are detected, the camera is called to take a picture of the image currently displayed in the view window.

S15: displaying the view window of the camera in a full-screen display mode.

If it is determined that the camera is not working in the window view mode, the view window is displayed in a full-screen display mode.

Therefore, the present embodiment may preset the working mode of a camera to be a full-screen view mode or a window view mode when the camera needs to be called for photographing during the running of an application, and when the camera is called for photographing during the running of the application, determines that the working mode of the camera is the window view mode, then displays the view window in a small screen display mode on the application interface of the application. As a result, it can shoot by calling the camera according to a photographing action command for the view window, shoot pictures at the same time when the application is running, and the window for photographing pictures does not affect the current application interface. The photographing operations thereof are simple and convenient, and the user experience is improved.

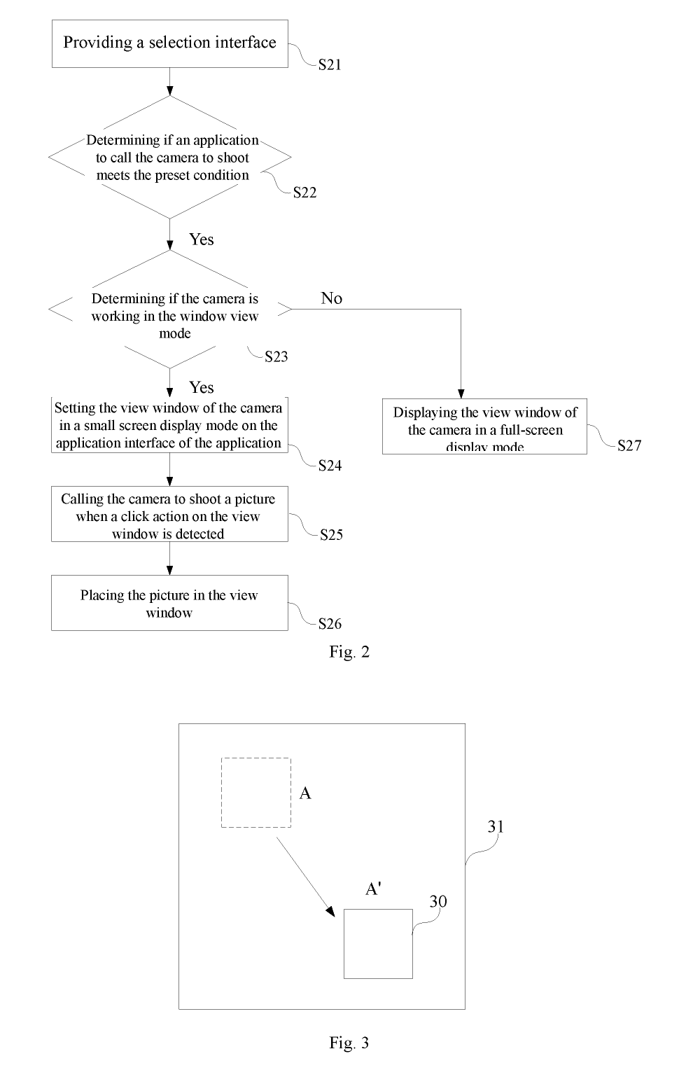

Referring to FIG. 2, FIG. 2 is a flow chart of a second embodiment of a mobile terminal-based photographing method according to the present invention. As shown in FIG. 2, the photographing method according to the present embodiment comprises:

S21: providing a selection interface.

The step S21 is similar to the step S11, which will not be repeated herein.

S22: determining if an application to call the camera to shoot meets the preset condition.

After the user selection is recorded, during the running of an application, further determining if an application to call the camera to shoot meets the preset condition, wherein the preset condition includes, but is not limited to, the camera icon on the application interface of the application is clicked or a side button of the mobile terminal is pressed. If the preset condition is met, go to Step S23, if not, then only displaying the application interface of the current application.

S23: determining if the camera is working in the window view mode.

When the current application to call the camera to shoot meets the preset condition, further determining if the camera is working in the window view mode, if yes, go to Step S24, if no, go to Step S27.

S24: setting the view window of the camera in a small screen display mode on the application interface of the application.

When it is determined that the camera is working in the window view mode, setting the view window of the camera in a small screen display mode on the application interface of the application, the view window includes, but is not limited to, floating above the application interface, and does not affect the operation of the current application.

S25: calling the camera to shoot a picture when a click action on the view window is detected.

The step S25 is similar to the step S14, which will not be repeated herein.

S26: placing the picture in the view window.

In the present embodiment, when a camera is called to take a picture, the picture is placed in the view window within a preset time threshold, e.g. 30 s. When the time goes beyond 30 s, the picture is automatically deleted or automatically saved to a default storage path, which is not limited herein.

Moreover, the view window is set in such a way that, when a user clicks the edge of the view window and conducts a drag action, the position of the view window moves in the dragging direction. As shown in FIG. 3, when the edge of the view window 30 is pressed and dragged, the view window 30 moves from Position A to Position A′. In other embodiments, it may also be set that a user clicks other positions of the view window and drags, such that the view window 30 moves to other positions of the application interface.

Furthermore, when the picture is in the view window 30, if the view window 30 is dragged to an operating field of the application interface, the picture is used as an operating object of the operating field. For example, in the WeChat application, the view window 30 is dragged to a WeChat content under editing, then the picture is shared through WeChat.

S27: displaying the view window of the camera in a full-screen display mode.

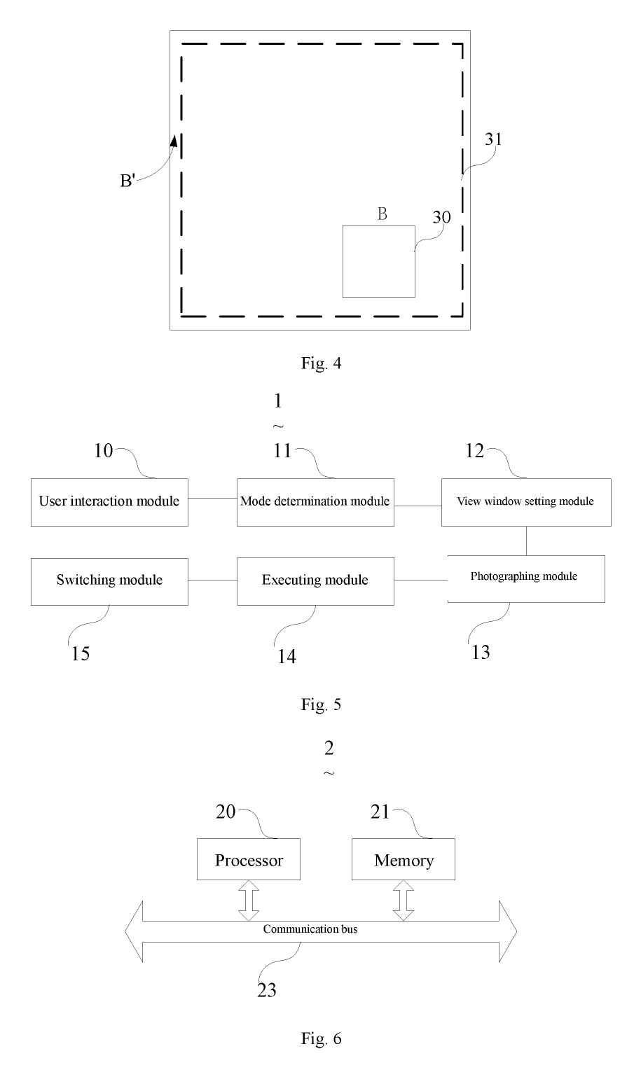

When it is determined that the camera is not working in the window view mode, displaying the view window in a full-screen display mode, and when a double click operation or a satisfying preset gesture action is detected on the view window displayed in a full-screen display mode, setting the view window 30 in a small screen display mode on the application interface of the application. On the contrary, when the view window 30 is displayed in a small screen display mode, and when a gesture action on the view window is detected to satisfy the preset gesture action, displaying the view window of the camera in a full-screen display mode, wherein the preset gesture action includes, but is not limited to, a two-finger expand gesture. As shown in FIG. 4, when the view window 30 is displayed in a small screen mode on the application interface 31, the view window 30 is on Area B of the application interface, when a two-finger expand gesture on the view window is detected, switching the view window to the full-screen display mode, as shown by Area B′ in FIG. 4. Moreover, when the view window 30 is displayed on Area B′, and when a double-click action on the view window 30 is detected, switching the view window 30 to the small screen display mode on the application interface, namely switching the view window 30 to display on Area B. Preferably, Area B′ covers the application interface 31. In other embodiments, Area B′ may also be set to other sizes, shapes and dimensions, for example, set to making the view window 30 to change to different shapes as a user's finger changes gestures, and using the points that the fingers reach as the edge of the view window.

The present embodiment describes with a smart phone as the mobile terminal 1 and a WeChat program as an example, and it implements the following scenario:

Presetting a default working mode of a camera when the camera needs to be called for photographing during the running of the WeChat program, preferably setting the default working mode to be a window view mode. During the running of the WeChat program, if it is necessary to call the camera to shoot a picture, clicking the camera icon on the WeChat application or pressing the camera shortcut start button on the side of the cell phone, and further determining if the camera is working in the window view mode, if it is determined that the camera start mode of the current WeChat program is a window view mode, then setting the view window of the camera displayed in a full-screen display mode in a small screen display mode on the application interface of WeChat, and the view window does not affect the content currently displayed by WeChat.

When the cell phone detects a click action on the view window, moreover, calling the camera to shoot a picture, and placing the picture taken in the view window, for example, the picture is placed in the view window within a preset time threshold, e.g. 30 s. When the time goes beyond 30 s, the picture is automatically deleted or automatically saved to a default storage path, e.g. saved to an image library. Within the preset 30 s, moreover, if a user clicks and drags the picture to an operating field of the application interface of WeChat, then the picture is added to WeChat for sharing. Moreover, the view window may be switched to the full-screen view mode according to operating commands of the user. For example, under the current window view mode, the window view mode is switched to the full-screen view mode if the user makes a two-finger expand gesture on the view window, namely the view window is switched from a small screen display mode to the full-screen display mode and covers above the application interface. In the full-screen view mode, moreover, if the cell phone detects that the user double clicks the screen, then the view window is switched to the small screen display mode and displayed above the application interface.

Please further referring to FIG. 5, FIG. 5 is a block diagram of the principle of the mobile terminal according to the present invention, wherein, the photographing methods in the embodiments of FIG. 1 and FIG. 2 are both described on the basis of the mobile terminal in FIG. 5. As shown in FIG. 5, the mobile terminal 1 in the present embodiment comprises a user interaction module 10, a mode determination module 11, a view window setting module 12 and a photographing module 13 that are sequentially connected. Wherein, the user interaction module 10 is configured for a user to select a full-screen view mode or a window view mode in which a camera works when the camera needs to be called for photographing during the running of an application, and record the user selection. The mode determination module 11 is configured to determine if the camera is working in the window view mode before an application needs to call the camera to shoot. The view window setting module 12 is configured to set the view window of the camera in a small screen display mode on the application interface of the application when the camera is working in the window view mode, and when the mode determination module 11 determines if the camera is not working in the window view mode, the view window setting module 12 displays the view window of the camera in a full-screen display mode. The photographing module 13 is configured to call the camera to shoot a picture when a click action on the view window is detected, and to place the picture taken in the view window. In addition, the mode determination module 11 is further configured to determine if an application to call the camera to shoot meets the preset condition, the preset condition being that the camera icon on the application interface of the application is clicked or a side button of the mobile terminal 1 is pressed. When a user clicks the edge of the view window and conducts a drag action, the view window setting module 12 moves the position of the view window in the dragging direction to a position that the view window is dragged to.

Moreover, the mobile terminal 1 further comprises an executing module 14 and a switching module 15, the executing module 14 is connected to the photographing module 13 and the switching module 15, respectively, the executing module 14 is configured to, when the view window is dragged to an operating field of the application interface, use the picture as an operating object of the operating field, such that the picture is shared or sent through the current application. The switching module 15 is configured to, in the window view mode, switch the view window to a full-screen display mode when a preset gesture action is detected on the view window displayed in a small screen display mode, the preset gesture action may be a two-finger expand gesture, and in the full-screen view mode, when the switching module 15 detects a double click operation on the view window displayed in a full-screen display mode, it switches the view window of the camera to a small screen display mode on the application interface of the application.

Referring to FIG. 6, FIG. 6 is a structural schematic diagram of the hardware of the mobile terminal according to the present invention. As shown in FIG. 6, the mobile terminal 2 comprises at least one processor 20, a memory 21 and at least one communication bus 22, and the processor 20 may be CPU. The communication bus 22 is configured to connect all elements, the memory 21 stores a program, and the program can be executed by the processor 20. In addition, the processor 20 is further used to execute executable modules stored in the memory 21, such as other computer programs. The memory 21 may include a high-speed Random Access Memory (RAM), or may include a non-volatile memory, for example, at least one magnetic disk storage.

In the present embodiment, the communication bus 22 is connected to the processor 20 and the memory 21, respectively, and the program stored in the memory 21 is specifically used:

For a user to select a full-screen view mode or a window view mode in which a camera works when the camera needs to be called for photographing during the running of an application, and record the user selection, determine if the camera is working in the window view mode before an application needs to call the camera to shoot, set the view window of the camera in a small screen display mode on the application interface of the application when it is determined that the camera is working in the window view mode, call the camera to shoot a picture when a click action on the view window is detected, and then place the picture in the view window.

Moreover, the program is further used to set the view window in such a way that, when a user clicks the edge of the view window and conducts a drag action, the position of the view window moves in the dragging direction, and when the view window is dragged to an operating field of the application interface, use the picture as an operating object of the operating field.

Moreover, the program is further used to execute the call of the camera by the application for photographing when a preset condition is met, wherein the preset condition includes that the camera icon on the application interface of the application is clicked or a side button of the mobile terminal is pressed, namely the shortcut start button of the camera is pressed.

Furthermore, the program is further used to:

When it is determined that the camera is not working in the window view mode, display the view window of the camera in a full-screen display mode, when a double click operation is performed in the view window displayed in a full-screen display mode, switch the view window of the camera to a small screen display mode on the application interface, and when a preset gesture action is detected in the view window displayed in a small screen in the window view mode, switch the view window from the window view mode to the full-screen view mode to display the view window in the full-screen view mode, the preset gesture action may be a two-finger expand gesture.

In addition, if the above functions of the embodiments of the present invention are implemented in the form of software functional units and sold or used as independent products, they may be stored in a computer-readable storage medium, namely the embodiments of the present invention may be implemented in the form of software products, which comprise a number of commands to make a computer device (which may be a personal computer, a server or a network device) to execute all or a part of steps of the methods according to the embodiments of the present invention.

In summary, the present invention provides a selection interface in advance and records the selection by a user of a full-screen view mode or a window view mode in which a camera works when the camera needs to be called for photographing during the running of an application, consequently when determining that the camera is working in the window view mode before an application needs to call the camera to shoot, the present invention sets the view window of the camera in a small screen display mode on the application interface of the application, such that the camera can be called to shoot a picture when a click action on the view window is detected, thereby simplifying the user operation and improving the user experience.

Preferred embodiments of the present invention are described above with reference to the drawings, which is not to limit the scope of the present invention. Any modification, equivalent substitution and improvement made by those skilled in the art without departing from the scope and essence of the present invention shall be encompassed in the scope of the present invention.

1. A mobile terminal, wherein the mobile terminal comprises: a processor, a memory and a communication bus, the communication bus is connected to the processor and the memory, respectively, the memory is used to store a program, and the processor is used to execute the program in the memory; the program is used to:
Provide a selection interface for a user to select a full-screen view mode or a window view mode in which a camera works when the camera needs to be called for photographing during the running of an application, and record the user selection;
Determine if the camera is working in the window view mode before an application needs to call the camera to shoot;
Set the view window of the camera in a small screen display mode on the application interface of the application when the program determines that the camera is working in the window view mode;
Display the view window of the camera in a full-screen display mode when a preset gesture action is detected on the view window displayed in a small screen display mode;
Call the camera to shoot a picture when a click action on the view window is detected or a physical side button of the mobile terminal is pressed;
Place the picture in the view window.

2. The mobile terminal according to claim 1, wherein, the program presets a preset condition for an application to call the camera,
and the program further determines if the step of an application to call the camera to shoot meets the preset condition, wherein the preset condition is:
The camera icon on the application interface of the application is clicked; or
The side button of the mobile terminal is pressed.

3. The mobile terminal according to claim 1, wherein, the program sets the view window in such a way that, when a user clicks the edge of the view window and conducts a drag action, its position moves in the dragging direction.

4. The mobile terminal according to claim 3, wherein, the program sets the view window in such a way that, when it is dragged to an operating field of the application interface, the picture is used as an operating object of the operating field.

5. The mobile terminal according to claim 1, wherein, the program is further used to,
when it is determined that the camera is not working in the window view mode, display the view window of the camera in a full-screen display mode.

6. The mobile terminal according to claim 5, wherein, the program is further used to,
when a double click operation is detected on the view window displayed in a full-screen display mode, set the view window of the camera in a small screen display mode on the application interface of the application.

7. The mobile terminal according to claim 1, wherein, the preset gesture action is a two-finger expand gesture.

8. A mobile terminal, wherein the mobile terminal comprises: a processor, a memory and a communication bus, the communication bus is connected to the processor and the memory, respectively, the memory is used to store a program, and the processor is used to execute the program in the memory; the program is used to:
Provide a selection interface for a user to select a full-screen view mode or a window view mode in which a camera works when the camera needs to be called for photographing during the running of an application, and record the user selection;
Determine if the camera is working in the window view mode before an application needs to call the camera to shoot;
Set the view window of the camera in a small screen display mode on the application interface of the application when the program determines that the camera is working in the window view mode;
Call the camera to shoot a picture when a click action on the view window is detected or a physical side button of the mobile terminal is pressed.

9. The mobile terminal according to claim 8, wherein, the program is further used to place the picture in the view window, and the program sets the view window in such a way that, when a user clicks the edge of the view window and conducts a drag action, its position moves in the dragging direction, and when the view window is dragged to an operating field of the application interface, uses the picture as an operating object of the operating field.

10. The mobile terminal according to claim 8, wherein, the program is further used to,
when it is determined that the camera is not working in the window view mode, display the view window of the camera in a full-screen display mode; when a double click operation is detected on the view window displayed in a full-screen display mode, set the view window of the camera in a small screen display mode on the application interface of the application.

11. The mobile terminal according to claim 8, wherein, the program is further used to, when a preset gesture action is detected on the view window displayed in a small screen display mode, display the view window of the camera in a full-screen display mode, the preset gesture action being a two-finger expand gesture.

12. A mobile terminal-based photographing method, wherein, the method comprises:
Providing a selection interface for a user to select a full-screen view mode or a window view mode in which a camera works when the camera needs to be called for photographing during the running of an application, and recording the user selection;
Determining if the camera is working in the window view mode before an application needs to call the camera to shoot;
If yes, setting the view window of the camera in a small screen display mode on the application interface of the application;
Calling the camera to shoot a picture when a click action on the view window is detected or a physical side button of the mobile terminal is pressed.

13. The method according to claim 12, wherein, the step that an application needs to call the camera to shoot is carried out when a preset condition is met, wherein the preset condition is:
The camera icon on the application interface of the application is clicked; or
The side button of the mobile terminal is pressed.

14. The method according to claim 12, wherein, after the step of calling the camera to shoot a picture when a click action on the view window is detected, the method further comprises:
Placing the picture in the view window.

15. The method according to claim 14, wherein, the view window is set in such a way that, when a user clicks the edge of the view window and conducts a drag action, its position moves in the dragging direction.

16. The method according to claim 15, wherein, when the view window is dragged to an operating field of the application interface, the picture is used as an operating object of the operating field.

17. The method according to claim 12, wherein, the method further comprises:
When it is determined that the camera is not working in the window view mode, displaying the view window of the camera in a full-screen display mode.

18. The method according to claim 17, wherein, the method further comprises:
When a double click operation is detected on the view window displayed in a full-screen display mode, setting the view window of the camera in a small screen display mode on the application interface of the application.

19. The method according to claim 12, wherein, the method further comprises:
When a preset gesture action is detected on the view window displayed in a small screen display mode, displaying the view window of the camera in a full-screen display mode.

20. The method according to claim 19, wherein, the preset gesture action is a two-finger expand gesture.
